(19) United States
(12) Patent Application Publication
(10) Pub. No.: US 2003/0085004 A1
(43) Pub. Date: May 8, 2003

(54) Pull cord for coverings for architectural openings and method of making same

(75) Inventors: Kenneth W. Witherell, Charlotte, NC (US); Klas Ture Ivarsson, Kullavik (SE)

Correspondence Address: DORSEY & WHITNEY, LLP, INTELLECTUAL PROPERTY DEPARTMENT, 370 SEVENTEENTH STREET, SUITE 4700, DENVER, CO, 80202-5647, US

(73) Assignee: Turnils AB, Alingsas (SE)

(21) Appl. No.: 10/256,503

(22) Filed: Sep. 26, 2002

Related U.S. Application Data
(63) Continuation-in-part of application No. 10/113,687, filed on Mar. 28, 2002, now abandoned.
Application No. 10/113,687 is a continuation of application No. 09/655,991, filed on Sep. 6, 2000, now abandoned.
(60) Provisional application No. 60/152,824, filed on Sep. 7, 1999.

(51) Int. Cl. A47H 1/00; E06B 9/56

(52) U.S. Cl. 160/330; 87/1; 57/9

(57) ABSTRACT

A method of manufacturing a control cord for use in a covering for architectural openings includes the steps of providing spools of high tensile strength and low abrasion characteristic yarns, tensioning the yarns and winding the yarns under tension on bobbins, placing the bobbins in a braiding apparatus and making an eight-carrier braid from the yarns on the bobbins, and passing the braided cord through a treatment apparatus where a urethane coating is applied to the yarns and heat cured.

### CROSS-REFERENCE TO RELATED APPLICATIONS

This application is a continuation-in-part of U.S. application Ser. No. 10/113,687, filed Mar. 28, 2002, which is a continuation of U.S. application Ser. No. 09/655,991, filed Sep. 6, 2000, abandoned, which claims the benefit of U.S. provisional patent application No. 60/152,824, filed Sep. 7, 1999. Each of the above-identified applications is hereby incorporated by reference as though fully disclosed herein.

### BACKGROUND OF THE INVENTION

1. Field of the Invention

The present invention relates generally to pull cords used in coverings for architectural openings and more particularly to a braided pull cord and the method of making the cord.

2. Description of the Relevant Art

Most coverings for architectural openings, such as windows, doors, archways and the like, have an operating mechanism that is controlled by a flexible element that can be a fiber based cord, a beaded chain or the like. The control cord or the like typically depends from one end of a headrail for the covering and extends into the headrail through a friction brake and subsequently through carrier elements and around a plurality of pulleys and the like that are associated with the operation of the covering. As a result, the control cord is frictionally engaged at a number of locations and, depending upon the frequency of operation of the covering and the abrasiveness of the elements with which the cord comes into contact, the control elements can easily deteriorate.

In the case of fiber based cords, the abrasion caused by the various elements in which it comes into contact, causes rapid deterioration of the cords. Cords that have deteriorated have to be replaced and many operating cords in coverings for architectural openings are replaced on an annual basis. When the covering has been warranted, the replacement cost is borne by the manufacturer and, accordingly, the quality and longevity of control cords is a significant economic factor in the covering industry.

A typical fiber based cord used in coverings for architectural openings is braided from polyester fibers, with the cords typically including sixteen carrier fibers. After braiding of the cord, it is heat treated and wound on storage rolls before being incorporated into a covering product. The braid is relatively tight.

In trying to resolve the problem of rapidly deteriorating operating cords, applicants initially looked to the hardware of the system to remove any abrasive surfaces across which the cord had to pass. By redesigning various plastic molded parts and the parting lines in the plastic molds for the parts, the wear cycle was improved. The redesigned components were later coated with low friction materials such as Teflon® or zinc to reduce abrasion, but only marginal improvement was noticed. Further, the coatings tended to wear off over time and with exposure to UV light. Applicants then decided that the focus for improving the wear cycle of operating cords needed to be on the cord itself and it is to this end that the present invention has been made.

### SUMMARY OF THE INVENTION

The cord of the present invention is made from high tensile strength fibers with low abrasion characteristics, such as polyethylene or polyester fibers. The fibers are braided in an eight or sixteen-carrier braid that is wound under very high tension and ultimately finished with a chemical coating that is heat cured. The resultant products have provided wear cycles of many times that achieved with state-of-the-art cords thereby almost removing the problem of manufacturers in having to re-cord coverings for architectural openings. In accordance with the method for making the eight or sixteen-carrier braid, high tensile strength fibers with low abrasion, such as might be polyethylene or polyester fibers, are wound under high tension onto yarn bobbins and the yarn bobbins are then utilized in a conventional braiding apparatus to braid the cord under high tension. The braided cord is held under tension and passed through a two-stage heat setting process wherein a chemical coating of a urethane solution or a polysiloxane solution is applied to the braided cord in the first stage and the coating is heat cured in the second stage. After the second stage of heating, the cord is wound onto spools for storage until they are strung into coverings for architectural openings.

Other aspects, features and details of the present invention can be more completely understood by reference to the following detailed description of a preferred embodiment, taken in conjunction with the drawings and from the appended claims.

### BRIEF DESCRIPTION OF THE DRAWINGS

FIG. 1 is a block diagram illustrating the steps in the process of making the cord in accordance with the present invention.

FIG. 2 is a fragmentary diagrammatic isometric view showing yarn from which the cord will be braided being passed from supply spools under tension to bobbins.

FIG. 3 is a fragmentary isometric illustrating the bobbins carrying the yarns under tension and being positioned in a braiding apparatus and with the braided cord being wrapped on a storage spool.

FIG. 4 is a diagrammatic view showing yarn from storage spools being passed through a two-stage process for coating the yarns with urethane and heat curing the urethane on the yarn before accumulating the yarns on storage spools.

FIG. 5 is a fragmentary elevation showing the braided cord in accordance with the present invention.

FIG. 6 is a diagrammatic elevation showing a prior art braided cord.

### DESCRIPTION OF THE PREFERRED EMBODIMENT

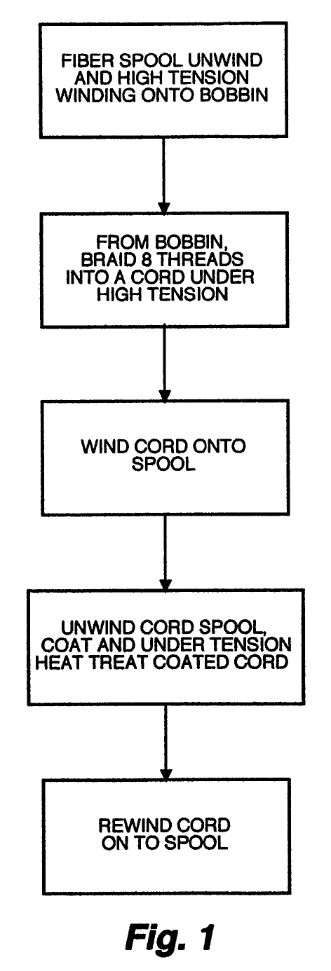

The method of making a braided control cord for use in coverings for architectural openings in accordance with the present invention is illustrated in a block diagram in FIG. 1. It will there be appreciated that fibers or yarns from which the cord is to be braided are first unwound from spools on which they are supplied and then wound under high tension onto bobbins. From the bobbins, yarns are braided into a cord also under high tension and the braided cord is subsequently wound on a transfer spool. The cords are unwound from the transfer spools under tension and fed into a treating apparatus where they are chemically coated and immediately heat cured in a two-stage process so that the chemical coating is dried and fully cured on the braided cords. After the coating has been heat cured, the yarn is stored on storage spools from which it can be removed when incorporating the cord into an operating mechanism for a covering for architectural openings.

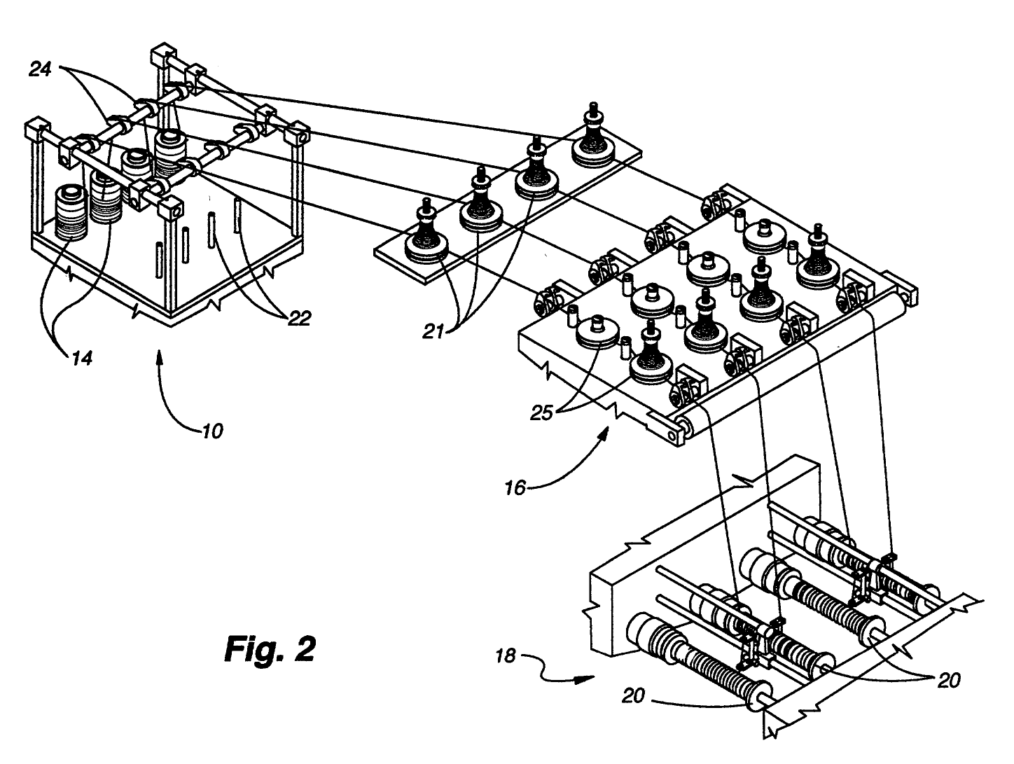

With reference to FIG. 2, a device 10 for unwinding yarn 12 from preformed spools 14 of yarn is shown in series with a conventional tensioning apparatus 16 for the yarns and a conventional apparatus 18 for wrapping the yarns on bobbins 20 under tension. To provide even greater tension in the yarn than is provided by the conventional tensioning apparatus 16, the yarns are passed through an additional but conventional washer tensioner (not shown) before they are received by the tensioning apparatus 16. The device 10 for unwinding the yarn from the spools 14 can be seen to include a plurality of spindles 22 on which the spools 12 of yarn are disposed and the yarn is threaded through low friction ceramic guides 24 associated with each spool so that they can be passed individually to the conventional tensioner (which is not shown) before passing on to the tensioning apparatus 16. In the tensioning apparatus, they are tensioned in a conventional manner with washer tensioners 25 so that the yarns 12 when passed down to the bobbins 20 are fed to and wound on the bobbins under tension. Each of the devices and apparatuses 10, 16 and 18 are conventional items such as manufactured by Ratera of Spain.

In one embodiment of the present invention, the yarns 12 have a high tensile strength in the range of 28-35 grams/denier, and preferably 30 grams/denier, and have low coefficients of friction, low abrasion characteristics and are durable from a flex fatigue standpoint. Examples of yarns that would be suitable for this purpose are Kevlar manufactured by Dupont in the United States, Nomex manufactured by Dupont, Twaron manufactured by Akzo of The Netherlands, Dyneema manufactured by DSM of Holland or Spectra manufactured by the Allied Signal Division of Honeywell, Inc., Petersburg, Va. The yarn or fibers for the first embodiment are preferably polyethylene. The tension under which the yarns 12 are wound on the bobbins 20 is preferably in the range of 115 to 140 grams and desirably 120 grams.

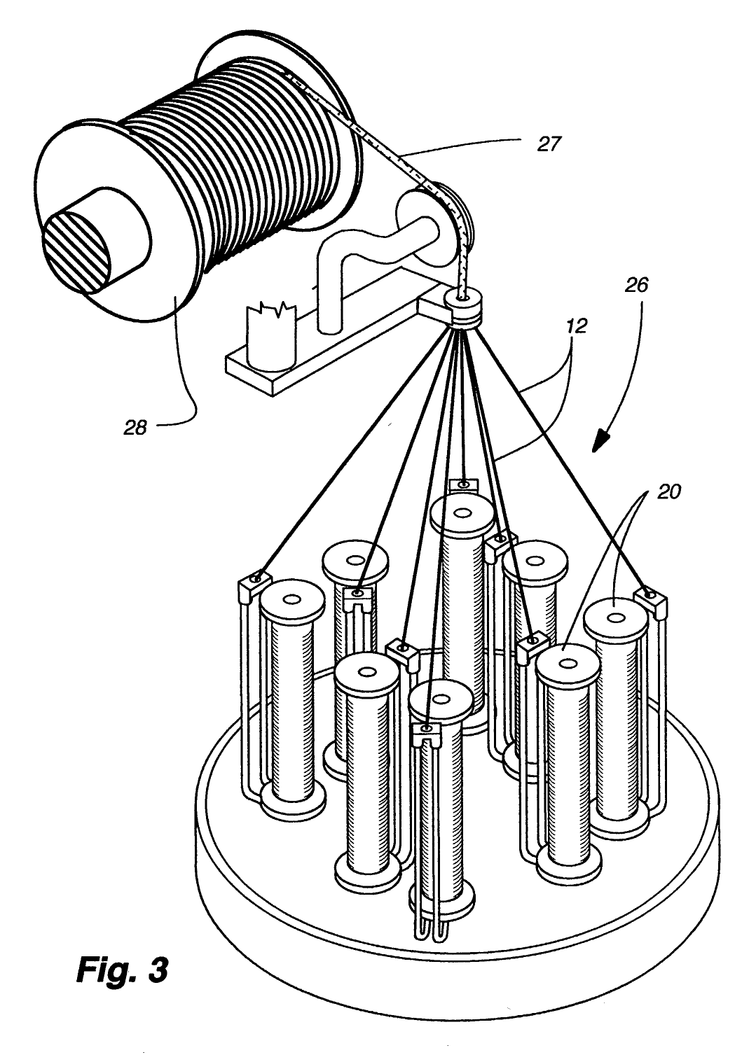

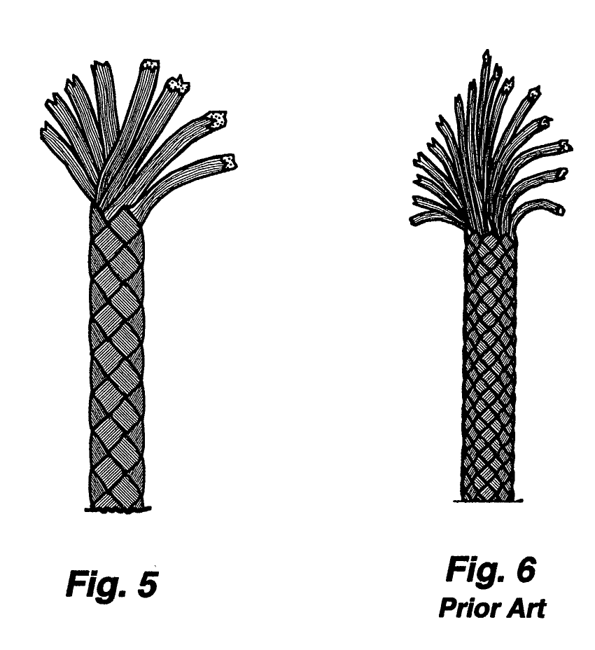

Looking next at FIG. 3, the bobbins 20 with the yarn 12 wound thereon under tension, are placed in a braiding apparatus 26 of a conventional type such as of the type manufactured by Ratera of Spain. In this first embodiment of the invention, eight yarns are braided into a cord 27 and after braiding, wound onto a transfer spool 28. The denier of the yarns is preferably in the range of 275 to 375, which is greater than the denier of yarns typically braided into control cords, as can be evidenced by reference to FIGS. 5 and 6, with FIG. 5 being a cord braided in accordance with the present invention and FIG. 6 a prior art braided cord. The tension under which the yarns are braided into the cord is preferably in the range of 100 to 120 grams and desirably 110 grams.

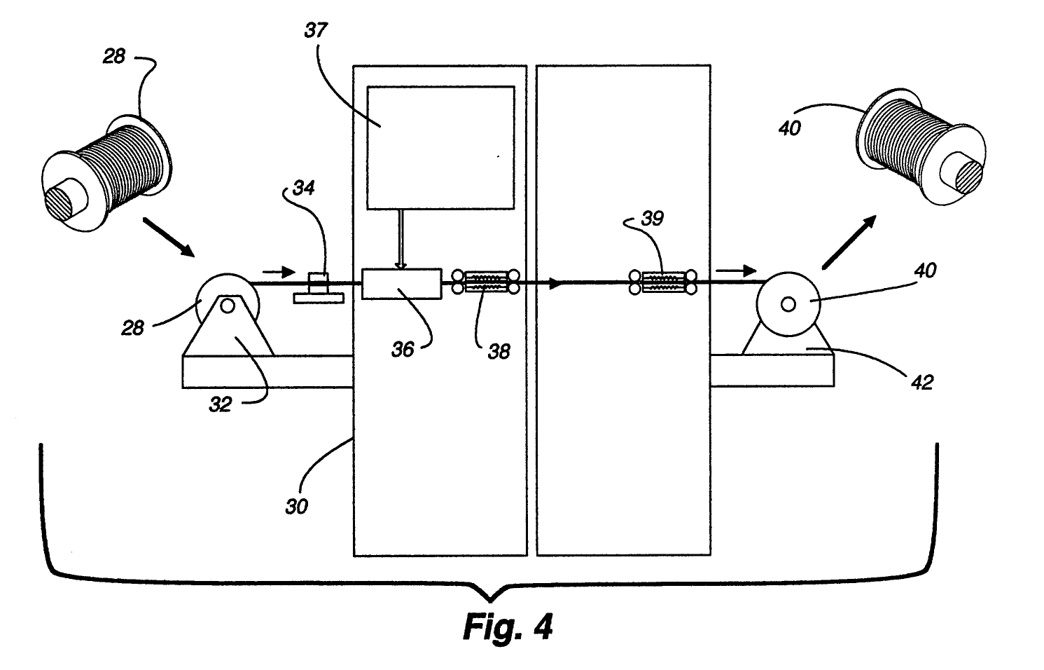

The transfer rolls of braided cord are then operatively connected to a treatment apparatus 30 (FIG. 4) for final treatment of the cord. Each transfer spool 28 of cord in this first embodiment is rotatably mounted on a bracket 32 on the upstream end of the apparatus 30 so that the cord can be fed into and through the treatment apparatus under tension via a conventional tensioner 34. The tension in the cord is preferably in the range of 150-200 grams and desirably 150 grams. In the apparatus, 30 the braided cord 27 is first fed through a chamber 36 where the cord is padded with a urethane solution coating that is applied to the cord. The chamber 36 is fed from a urethane solution reservoir 37. By way of example, the coating might be either sprayed onto the cord or the cord might be drawn through a bath of the urethane solution in order to apply the desired coating to the cord. The latter is preferred. Immediately after the cord is coated with the urethane solution, it is passed through a heating chamber or oven 38 where the urethane solution is dried. The temperature in the heating chamber 38 is preferably in the range of 120-140° C. even though temperatures outside that range would work as it would primarily affect the drying time. Subsequent thereto, the cord is passed through another heating chamber 39 where the urethane solution is cured. The temperature in the curing chamber 39 is preferably in the range of 100-120° C. even though, again, temperatures outside that range would work as the temperature primarily affects the curing time. The total time for drying and curing should ideally be in the range of 60-120 seconds, with 90 seconds being desired. After the cord 27 has been padded with the urethane solution coating and cured, the final braided cord is wrapped onto a storage spool 40 that is rotatably mounted on brackets 42 at the downstream end of the apparatus 34. When a predetermined supply of the braided cord 27 is wound onto the storage spool 40, the spool is removed and retained for later use in the assembly of a covering for an architectural opening.

The apparatus 30 for treating the cord with a urethane solution and curing the cord is conventional and may be of the type manufactured by Andersson Mek of Sweden. The urethane solution is a mixture of urethane and water in a concentration of 10% urethane by volume. The urethane is miscible in/with water and preferably itself comes from the chemical family of polyester, polyether polyurethane dispersions and can come from various sources but a urethane marketed under the designation Baypret DLV Dispersion Corporation by Bayer Corporation of Pittsburgh, Pa., has been found suitable for the cord of the present invention.

A cord formed in accordance with the first described embodiment of the present invention and as illustrated in FIG. 5, has been found to provide a wear cycle that is approximately ten times that of conventional cords that are presently in use.

In an alternative embodiment, a control cord for a covering for an architectural opening is manufactured in accordance with the method described previously in the first embodiment except the materials used in the process are different and the parameters are somewhat different but again a cord with an extended life relative to conventional control cords is obtained. It should also be mentioned that the equipment for manufacturing this embodiment is identical to the equipment previously described for use in manufacturing the first embodiment except the cord of this embodiment is a 16-braid cord, rather than an 8-braid cord, requiring 16 bobbins of yarn as opposed to 8.

The second embodiment of the present invention is made from polyester yarns also of a high denier with the denier preferably being in the range of 205 to 220 and desirably 205. A suitable yarn is manufactured by Dupont and designated polyester type 68L with the yarn having 50 filaments per bundle and a tensile strength of 8.0 to 8.5 grams per denier.

The yarns are wound onto bobbins under a tension of 40 to 60 grams and desirably 50 grams. The yarns are braided into a sixteen-braided yarn under tension in the range of 60-80 grams.

After the yarns have been braided, they are chemically treated as in the previously described embodiment of the present invention except the chemical coating is a polysiloxane solution and specifically a 10% solution of an aqueous emulsion of a polyhydrogen methylsiloxane. The tension in the cord during coating is in the range of 150 to 200 grams and desirably 150 grams.

As mentioned previously, the processing of the materials in the second embodiment follows the same method previously described except under different operating parameters as described. A cord that has been braided and coated as described in accordance with the alternative embodiment has been found to extend the cycle life of a conventional polyester yarn cord by four times and is therefore a very suitable alternative to conventional control cords used in coverings for architectural openings.

Although the present invention has been described with a certain degree of particularity, it is understood that the present disclosure has been made by way of example, and changes in detail or structure may be made without departing from the spirit of the invention as defined in the appended claims.

1. A covering for an architectural opening comprising in combination:
covering means for selectively covering and uncovering the architectural opening by extension and retraction of said covering means; and
an operating mechanism mounted adjacent to said architectural opening and being operatively associated with said covering means, said mechanism including a braided control cord that was braided under high tension and chemically coated while under high tension, and operative elements having a low friction engaged with said control cord.

2. The covering of claim 1 wherein said yarn is wound on bobbins under a tension of 115 to 140 grams prior to being braided into said cord.

3. The covering of claim 1 or 2 wherein said cord is coated with a urethane solution.

4. The covering of claim 1 or 2 wherein said braided cord is placed under a tension of 150 to 200 grams and coated with said urethane solution prior to being incorporated into said operating mechanism.

5. The covering of claim 2 wherein said yarn is a polyethylene yarn.

6. The covering of claim 1 or 2 wherein the control cord is braided under a tension in the range of 100 to 120 grams.

7. A method of reducing the friction between a control cord of a covering for an architectural opening and an operational mechanism in the covering comprising the steps of:
braiding the control cord from a polyethylene yarn under tension, and
chemically coating said cord under tension.

8. The method of claim 7 wherein the chemical coating is a urethane solution.

9. The method of claim 7 or 8 wherein the step of braiding the cord from yarn includes the step of wrapping the yarn on bobbins under a tension in the range of 115 to 140 grams prior to braiding the cord and wherein the yarn for braiding is removed from the bobbins while under tension.

10. The method of claim 9 wherein said cord is coated while being held under a tension of 150 to 200 grams.

11. The method of claim 7 or 8 wherein the cord is braided from yarn under a tension in the range of 100-120 grams.

12. The covering of claim 1 wherein said yarn is wound on bobbins under a tension of 40-60 grams prior to being braided into said cord.

13. The covering of claim 1 or 12 wherein said cord is coated with a polysiloxane solution.

14. The covering of claim 12 wherein said yarn is a polyester yarn.

15. The covering of claim 12 or 14 wherein said cord is braided under a tension of 60-80 grams.

16. A method of reducing the friction between a control cord of a covering for an architectural opening and an operational mechanism in the covering comprising the steps of:
braiding the control cord from a polyester yarn under tension, and
chemically coating the cord under tension.

17. The method of claim 16 wherein the chemical coating is a polysiloxane solution.

18. The method of claim 16 or 17 wherein the step of braiding the cord from yarn includes the step of wrapping the yarn on bobbins under a tension in the range of 40-60 grams prior to braiding the cord and wherein the yarn for braiding is removed from the bobbins and braided under a tension of 60-80 grams.

19. The method of claim 18 wherein said cord is coated while being held under a tension of 150 to 200 grams.
